(19) United States
(12) Patent Application Publication
(10) Pub. No.: US 2008/0020801 A1
(43) Pub. Date: Jan. 24, 2008

(54) Managing Wireless Base Stations Using A Distributed Virtual Base Station Manager

(76) Inventors: Nestor Alexis Fesas, Austin, TX (US); Duy Khuong Do, Melbourne (AU); Charles Arthur Willman, Austin, TX (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/780,976

(22) Filed: Jul. 20, 2007

Related U.S. Application Data
(60) Provisional application No. 60/832,407, filed on Jul. 20, 2006.

(51) Int. Cl. H04B 1/38

(52) U.S. Cl. 455/561

(57) ABSTRACT

To manage a group of wireless base stations (WBS), a network administrator accesses one of the WBS, which serves as the management point. The management point WBS distributes parameters to each WBS to configure each WBS. Each WBS has logic thereon to that allows the WBSs to discover one another and self-organize into one or more clusters of WBSs. The WBSs cooperate to select one of the WBS as a master of each cluster. Furthermore, the logic on each WBS provides for a failure mechanism such that if the master becomes inoperable, another WBS is promoted to master. These self-organized clusters of WBSs collaborate to provide a variety of services, such as fast handoff of client devices, load balancing, and rogue device detection/mitigation. Based on the foregoing, there is no single point of failure.

### RELATED APPLICATION

This application claims priority to U.S. Provisional Patent Application No. 60/832,407, entitled “DISTRIBUTED METHOD FOR MANAGING A PLURALITY OF WIRELESS BASE STATIONS USING A VIRTUAL BASE STATION CONTROLLER,” filed on Jul. 20, 2006 by Nestor Fesas et al., the contents of which are incorporated herein by reference in their entirety for all purposes.

### FIELD OF THE INVENTION

The methods described herein embody mechanisms for managing wireless base stations (WBS) without the use of dedicated or centralized control hardware.

### BACKGROUND

Wireless networks typically include a number of wireless base stations (WBS) that serve as wireless access points (APs) to which a client device establishes wireless communication to access the wireless network. Managing the operation of the wireless network requires that each individual WBS be configured and maintained. Configuring and maintaining the WBS involves providing initial parameters to configure the WBS and updating the parameters as needed. These parameters may be related to the operation of the WBS radio interface, such as the channel on which the WBS is to operate, maximum power at which the WBS is to transmit, antenna selections, supported data rates, and timing for the periodic announcements of the wireless network. Other parameters could include the SSID (Service Set Identifier) of the wireless network, allowed authentication methods, authentication server addresses, pre-shared keys for WLANs or authentication servers, VLAN (Virtual Local Area Network) associations, and IP addresses and netmasks. An example protocol for managing WBSs is the CAPWAP (Control and Provisioning of Wireless Access Points) protocol (“CAPWAP Protocol Specification,” Version 6, Network Working Group, Internet Draft, April 2007).

One technique for managing WBSs is a management interface resident on each individual WBS. However, when using a management interface resident on each WBS, each WBS must be managed individually. Thus, a network administrator must perform the same, repetitive configuration steps on each WBS, thus making management cumbersome, inefficient and error prone.

Another technique for managing WBSs is a (centralized) management appliance embodied as a device attached to a network accessible by each WBS. In addition to management functions, the centralized management appliance typically performs such functions as encryption and authentication. Therefore, each WBS has very little intelligence in this approach. For example, the WBS captures frames on the wireless medium and passes them directly, without translation or interpretation to the centralized management appliance, which performs encryption/decryption, authentication, translation, forwarding, etc.

In the centralized management approach, the network administrator only needs to access the centralized management appliance to manage each WBS. Thus, the centralized management approach has the benefit of doing away with the tedious mechanics and frailty of an administrator configuring each WBS individually. However, the centralized management approach also has several limitations.

One such limitation is that the centralized appliance forms a single point of failure. When the centralized appliance fails, the group of WBSs served by that centralized appliance ceases to function as well. Furthermore, each centralized appliance can only support a fixed number of WBSs. For every deployment, at least one centralized management appliance is required. Additional centralized appliances are required as the quotient of the number of WBSs in the deployment divided by the number of WBSs supported by the appliance plus one. This characteristic of centralized WBS management appliances makes them cost prohibitive for small deployments and for highly cost sensitive deployments. Additionally, WBS management appliances limit flexibility in configuration in that individual WBSs can be associated with one and only one appliance.

Based on the need for wireless communications and the limitations in the conventional approaches, an approach for managing wireless WBSs that does not suffer from the limitations of the prior approaches is highly desirable.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is an example architecture for a virtual WBS manager, in accordance with an embodiment of the present invention;

FIG. 2 depicts a relationship between managed network groups, service groups and resources, in accordance with an embodiment of the present invention;

FIG. 3 depicts a block diagram of an example WBS, in accordance with an embodiment of the present invention;

FIG. 4 shows software elements of an example WBS, in accordance with an embodiment of the present invention;

FIG. 5 is a flowchart illustrating a process of discovery and configuration, in accordance with an embodiment of the present invention;

FIG. 6 is a flowchart illustrating a process of roaming, in accordance with an embodiment of the present invention;

FIG. 7 is a flowchart illustrating a process of rogue detection and mitigation, in accordance with an embodiment of the present invention; and

FIG. 8 is a block diagram of a computer system on which embodiments may be implemented.

### DETAILED DESCRIPTION OF THE INVENTION

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention.

### OVERVIEW

Techniques disclosed herein provide centralized and automated remote management of WBS resources, as well as services provided by the WBS, without the cost and physical limitations of a centralized management appliance. Highly flexible, redundant and high performance deployments are made possible by each WBS having logic (e.g., software) thereon that allows each WBS to serve as a network management point.

In one embodiment, to manage a group of WBS, the network administrator accesses one WBS, which serves as the management point, via a management console. The management console may be communicatively coupled to each WBS to allow a network administrator to remotely manage each WBS through whichever WBS currently serves as the management point. As an example, the management console could be a personal computer coupled to an Ethernet switch that, in turn, is coupled to each WBS. The management console could reside in one of the WBS. Thus, as an alternative, the network administrator could directly access the management point WBS by, for example, a command line interface (CLI) of the WBS. Because any WBS may serve as the management point there is no single point of failure.

In another embodiment, information is gathered individually from each WBS. For example, the management console retrieves this information from each WBS. The WBS are individually configured by the management console to participate in specific management groups and with specific service groups. One of the WBS serves as a cluster master that disseminates information to the other WBS. As examples, the cluster master may disseminate information to facilitate roaming or initiate rogue mitigation. Each WBS has logic thereon that allows each WBS to discover one another and to self-organize into one or more clusters of WBS, in an embodiment. The WBS cooperate to select one of the WBS as a master of each cluster. Furthermore, the logic on each WBS provides a failure mechanism such that if the master becomes inoperable, another WBS is promoted to master.

These self-organized clusters of WBSs collaborate to provide a variety of services, such as fast handoff of client devices, load balancing, and rogue device detection/mitigation. As an example of collaborating to handoff a client device from one WBS to another, two or more WBSs in a cluster collect client device signal strength information and forward the information to a master WBS. The master WBS makes the handoff decision and coordinates the handoff by sending instructions to the pertinent WBSs.

Approaches described herein make it possible for small businesses (or other organizations having the cost sensitive attributes of a small business) to deploy and manage highly complex, feature rich and high performance wireless networks without the need for extensive knowledge of the internal workings of networks or of the RF propagation principles required to adequately plan such deployments.

### EXAMPLE VIRTUAL MANAGER ARCHITECTURE

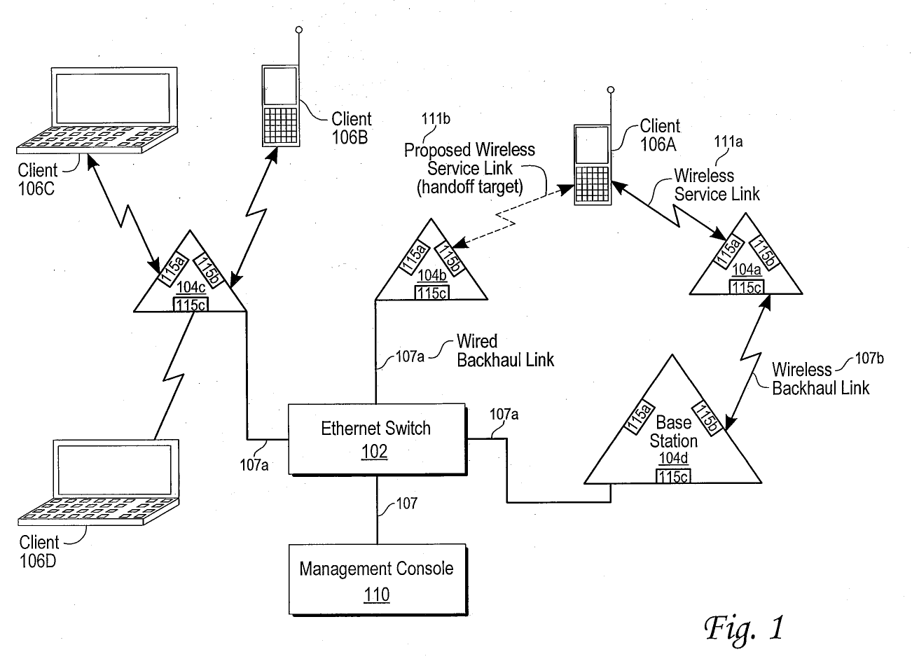

FIG. 1 is an example architecture for a virtual WBS manager, in accordance with an embodiment of the present invention, along with client devices 106a-d coupled thereto. The virtual manager architecture allows any of the WBS 104a-d to potentially function as a management point. In general, the architecture includes several WBS 104, an Ethernet switch 102, and a management console 110. Each WBS 104 is communicatively coupled to the Ethernet switch 102 through a wired backhaul link 107a, a wireless backhaul link 107b, or a combination of the two.

The management console 110 is communicatively coupled to each of the WBS 104 through the Ethernet switch 102. Thus, a network administrator may use the management console 110 to access any of the WBS 104, wherein a selected WBS 104 serves as the management point. The management console 110 may be implemented as a software application running on a personal computer or the like. The software application is able to query the network to determine information such as IP addresses of each WBS 104, WBS resources (e.g., radio interfaces 115), etc. and to present a graphical user interface that provides the network administrator with a selection of WBS 104 to configure. The network administrator can decide which WBSs 104 are to be grouped together for management purposes. The network administrator also can decide which resources within each WBS 104 should be used to implement a service, such as fast roaming, rogue device detection/mitigation, load balancing, etc. To manage each WBS 104, the management console 110 sends configuration parameters to the management point WBS 104.

As each WBS 104 powers on or is reset, it performs discovery in search of a cluster of WBS 104 to join. If no suitable cluster is found, a WBS 104 initiates formation of its own cluster. If a suitable cluster is found, the WBS 104 will join the cluster, adopt configuration parameters associated with the cluster, and commence providing services as defined for the cluster. One WBS 104 in the cluster acts as a master with the others acting as slaves, in an embodiment. If the master WBS 104 fails, the remaining WBSs 104 in the group execute a failover mechanism to select a new master, in an embodiment.

The WBSs 104 are communicatively coupled via the wired backhaul link 107a and/or wireless backhaul link 107b to allow the exchange of information. For example, the WBSs 104 exchange network configuration, management, and RF parameters via the backhaul links 107a, 107b. At least some of the information is exchanged to allow the WBSs 104 to collaborate to perform one or more services. Examples of services include, but are not limited to, roaming, load balancing, and rogue detection/mitigation. As a particular example of a roaming service, based on handoff information, client 106a is being handed off from WBS 104a, which provides wireless service link 111a, to WBS 104b, which provides proposed wireless service link 111b. The handoff decision may be based on signal strength information that is collected by WBS 104a and WBS 104b forwarded to a master WBS (e.g., 104c). Master WBS 104c makes the handoff decision and instructs WBS 104a and WBS 104b to make the handoff.

In one embodiment, the master WBS 104 and the slave WBSs 104 communicate with messages that are an extension of a CAPWAP protocol. “The CAPWAP Protocol Specification”, Version 6, Network Working Group, Internet Draft, April 2007; and “The CAPWAP Protocol Specification”, Version 1, Network Working Group, Internet Draft, May 5, 2006 are hereby incorporated herein in their entirety for all purposes. However, it is not a requirement that the messages be based on the CAPWAP protocol.

Each WBS 104 has multiple radios 115a-c or wireless interfaces (“WIF”) to allow the client devices 106 to access the network, in this embodiment. A WBS 104 could have any number of radios 115. The network administrator can select which WIF 115 to include in a group. For example, the network administrator might select one of the WIFs (e.g., 115a) from each WBS 104 to form a roaming service group, with the second WIF (e.g. 115c) from each WBS 104 to form a data service group (non-roaming) and with the third WIF 115b from each WBS 104 used to monitor RF communication for rogue device detection or other purposes.

### EXAMPLE HIERARCHY OF MANAGEMENT NETWORK GROUPS, SERVICE GROUPS AND RESOURCES

In one embodiment, a network administrator can use the management console 110 to configure each WBS 104 to establish network management groups (MNG), service groups, or another type of group. A MNG contains all of the WBS 104 that the network administrator has authorized to be on the network and wishes to manage as a group, in an embodiment. The MNG includes a group of WBS 104 that communicate with one another over the wired backhaul link 107a and/or wireless backhaul link 107b using the same security settings and encryption method, in one embodiment. The management console 110 may configure and maintain the MNG through a single WBS 104 that acts as the management point of the MNG. However, if the WBS 104 acting as the management point should fail, another WBS 104 steps in as the management point. Failover is accomplished as follows, in an embodiment. Each WBS 104 is configured with a cluster IP address, but only the master responds to datagrams addressed to the cluster IP address. On failover, the new master begins responding to the cluster IP address.

Each MNG can include many service groups (SG). A purpose of a SG is to map a class of service (e.g., security, voice roaming, load balancing, rogue detection/mitigation, etc.) to a set of resources (e.g., WIF 115, memory) in the WBS 104. Thus, a SG is a set of resources that are configured to implement some service. Therefore, the resources in an SG share a common service group configuration. The service group configuration may include, for example, an SSID (Service Set Identifier), BSSID (Basic Service Set Identifier), security configuration parameters, and channel number for the service.

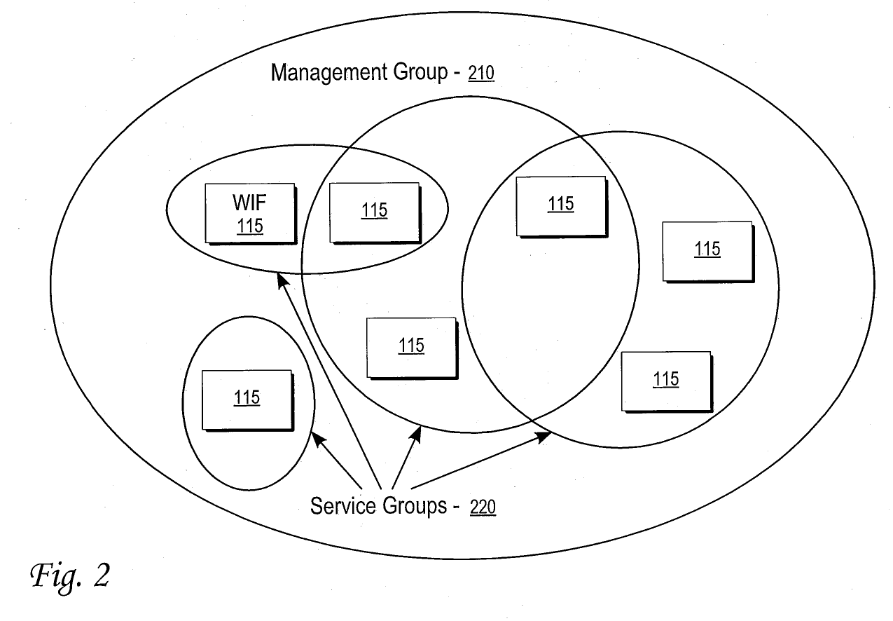

FIG. 2 depicts a relationship between MNGs 210, SGs 220 and resources, according to one embodiment. In this example relationship, the resources are WIFs 115. In particular, several SGs 220 that are a part of a MNG 210 are shown. Each SG 220 includes one or more WIFs 115, in this example. A particular resource (e.g., WIF 115) can belong to multiple SGs 220. An SG 220 can utilize WIFs 115 on all the WBSs 104 in a MNG 210 or any other subset of those WBSs 104. Thus, the relationship between WIFs 115 and SGs 220 may be many-to-many (many SGs 220 can be mapped to a WIF 115 and many WIFs 115 interfaces can be mapped to a SG 220). However, the many-to-many relationship is not a requirement.

The following example of setting up several SGs 220 will be used to illustrate how SGs 220 might be used. Consider a building divided into different regions in which different levels of wireless service are provided. A single WBS 104 may be used for wireless access to the lobby of the building. In this “lobby” SG 220, authorization to access the network could be low to allow guests to have wireless access. Of course, the nature of the access would be very limited. For example, the guests might only be able to access the Internet. Further, the security in the lobby SG 220 might be quite low. For example, no encryption might be used at all.

However, in the region in which executives work, the level of security might be very high. For example, to access the network the client 106 might have to authenticate to a backend server. Thus, one or more WBSs 104 in this “executive” region (or selected resources in the WBS 104) could be configured to implement an “executive” SG 220.

In an engineering region, the security might be medium. For example, lightweight authentication of the client 106 might be performed locally at the WBS 104. Thus, one or more WBS 104 in this “engineering” region (or selected resources in the WBS 104) could be configured to implement an “engineering” SG 220. In each region, configuration parameters that define how to implement the SG 220 are distributed to each WBS 104 in the SG 220 by the management point WBS 104.

### EXAMPLE BASE STATION

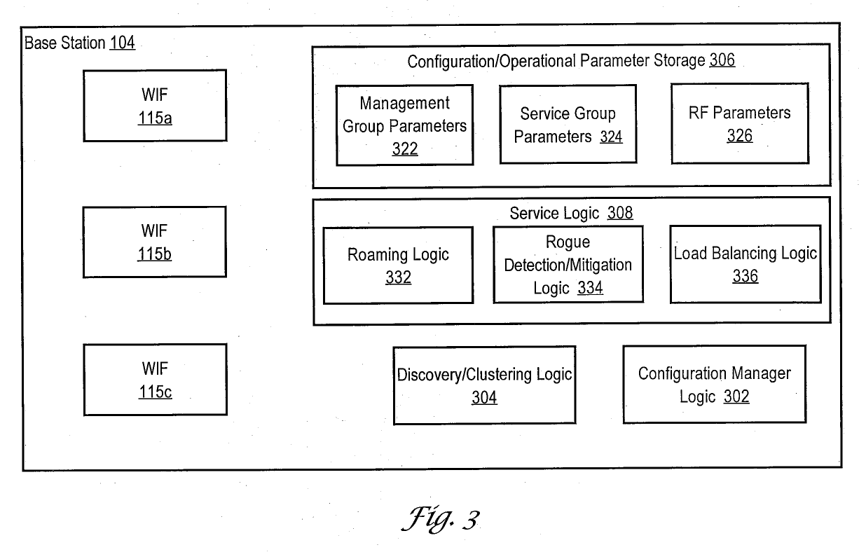

FIG. 3 depicts a block diagram of an example WBS 104, in accordance with an embodiment of the present invention. In general, the example base station 104 has three WIFs 115a-c, configuration manager logic 302, discovery/clustering logic 304, configuration/operational parameter storage 306, and service logic 308.

The configuration manager logic 302 allows the example WBS 104 to act as a management point and has an API that allows a software running on a management console 110 or the like to access the example WBS 104. Therefore, a network administrator can provide configuration parameters that are used to establish MNGs 210, SGs 220, or other parameters to configure a WBS 104. The configuration manager logic 302 distributes the received configuration parameters to other WBS 104 in the MNG 210, SG 220, etc. to configure each WBS 104. The configuration manager logic 302 also distributes operational parameters determined by the WBS 104, such as RF parameters.

The discovery/clustering logic 304 include algorithms to help the WBS 104 discover other WBSs 104 and for a group of WBSs 104 to self-organize into clusters. These algorithms select one of the WBSs 104 as a master, wherein the other WBSs 104 in the cluster serve as slaves. As an example, the WBS 104 having the lowest MAC address or IP address could be selected as the master. If the master should become inoperable, another WBS 104 is promoted to master. Therefore, there is not a single point of failure. The master WBS 104 may be the same WBS 104 as the management point WBS 104, but this is not requirement. After joining a cluster, the example WBS 104 may store a cluster ID in non-volatile memory. Even if the example WBS 104 has not joined a cluster, the WBS 104 can store a default cluster ID.

The configuration/operational parameter storage 306 stores MNG parameters 322, SG parameters 324, and RF parameters 326, in this embodiment. The MNG parameters 322 and SG parameters 324 might be provided by the management console 110 (through the management point WBS 104), whereas the RF parameters 326 might be determined and provided by whatever WBS 104 is acting as the cluster master. The configuration/operational parameters 322, 324, 326 and their point of origin are provided as illustrations. There could be other parameters that are not depicted in FIG. 3.

In one embodiment, the storage 306 includes a data structure that has attributes associated with various resources in the example WBS 104. For example, each WIF 115 may be assigned attributes such as, roaming group, data group, etc. Because each WBS 104 is configured according to the parameters 322, 324, 326, a great deal of flexibility is achieved. For illustrative purposes, the following SG parameters 324 might be stored for a SG:

SSID (Service Set Identifier)

BSSID (Basic Service Set Identifier)

Security Configuration
Authentication Type (e.g., local, remote)
Encryption Type

Resources participating in the service

Channel number for the service

The example WBS 104 has several different types of service logic 308, in this embodiment. The service logic 308 allows a cluster of WBS 104 to collaborate with each other to implement services such as fast roaming, load balancing, and rogue device detection/mitigation. In particular, the service logic 308 includes roaming logic 332, rogue device detection/mitigation logic 334, and load balancing logic 336. The service logic 308, the discovery/clustering logic 304, and configuration manager logic 302 may be implemented in software, hardware, or some combination of hardware and software.

### EXAMPLE SOFTWARE COMPONENTS OF A WBS

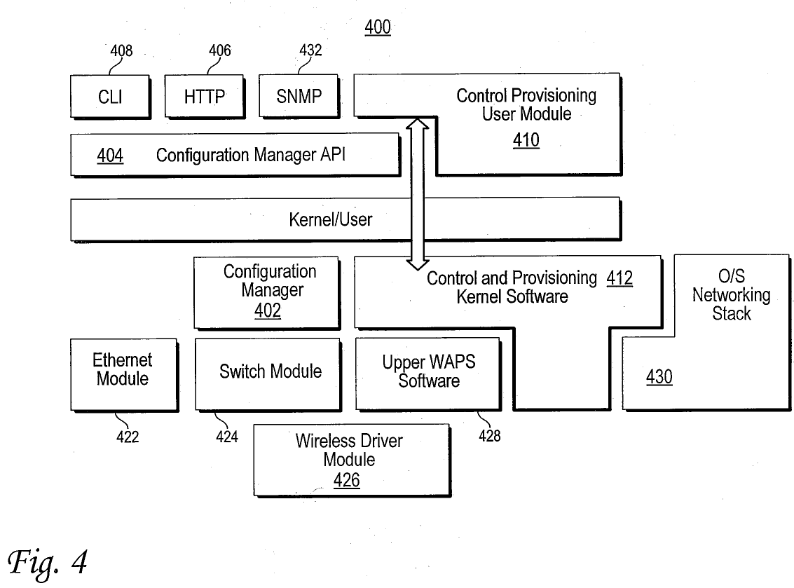

FIG. 4 shows example software elements 400 of a WBS 104, in accordance with an embodiment of the present invention. Some of software elements 400 can be used to implement the service logic 308, the discovery/clustering logic 304, and the configuration manager logic 302 of FIG. 3. However, the software elements 400 are not limited to being used in the example WBS 104 shown in FIG. 3.

The configuration manager module 402 comprises all of the management functionality required to configure and maintain a group of WBS 104. For example, the configuration manager module 402 is able to configure and maintain MNGs 210 and SGs 220. The configuration manager module 402 is accessed via the configuration manager API (CMAPI) 404, which may be accessed by either a central control point (e.g., management console 110) or by direct access to the WBS 104. As an example, the management console 110 can place a remote procedure call to the WBS 104. Direct access may be through a web interface (e.g., HTTP 406) or command line interface (CLI) 408. Thus, the CMAPI 404 is accessed to implement configuration operations, whether invoked directly at the WBS 104 or from the management console 110.

The control and provisioning modules 410, 412 include algorithms to implement discovery of other WBS 104 and self-organize into clusters of WBS 104. The discovery/clustering algorithms also select one of the WBS 104 as a master, wherein the other WBS 104 serve as slaves. However, should the master become inoperable, another WBS 104 is promoted to master. The master distributes configuration parameters to each WBS 104 in a cluster to configure and maintain each WBS 104.

Moreover, the control and provisioning modules 410, 412 are able to collaborate with other WBS 104 to implement services such as fast roaming, load balancing, and rogue device detection and mitigation. Control and provisioning is divided between a user module 410 and an O/S module 412, in this embodiment.

Also depicted in the software are an Ethernet module 422, a switch module 424, upper WAPS (wireless access point) software 428, a wireless driver module 426, an O/S networking stack 430, and SNMP module (Simple Network Management Protocol) 432.

### EXAMPLE PROCESS OF DISCOVERY, CLUSTERING, AND WBS CONFIGURING

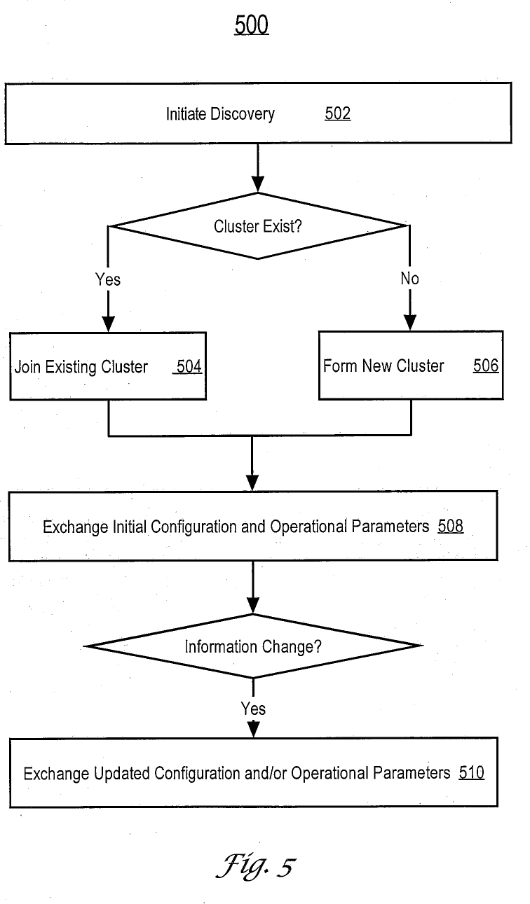

FIG. 5 is a flowchart illustrating a process 500 of discovery, cluster formation, and WBS configuration, in accordance with an embodiment. In step 502, an initializing WBS 104 initiates a discovery protocol. As previously discussed, a WBS 104 may store a cluster ID in non-volatile memory. This may be a cluster ID of a cluster that the WBS 104 previously joined or, if the WBS 104 has not joined a cluster, the WBS 104 can store a default ID. To initiate discovery, as each WBS 104 initializes after power up or after a system reset, it emits an IP multicast that indicates the stored cluster ID, in an embodiment. Furthermore, the multicast may indicate other information, such as security information for that WBS 104.

If the master WBS 104 in the cluster receives the multicast, it replies with a unicast datagram which may include the cluster ID, master WBS 104 security information, and cluster configuration parameters. The cluster configuration parameters can specify the master WBS 104, peer WBS 104, cluster RF parameters, etc. Based on the response datagram, the initializing WBS 104 now has all the information to join the cluster and to exchange operational data securely with the master WBS 104.

If the initializing WBS 104 discovers a desired cluster, the initializing WBS 104 joins the cluster, in step 504. For example, the initializing WBS 104 may send a “join” request datagram to the master WBS 104 using the master's public encryption key. The master WBS 104 may respond using its public encryption key, thus providing cluster specific cryptographic information, in an embodiment. The master WBS 104 may distribute cluster operational parameters (e.g., SSID) to the base station.

If the initializing WBS 104 fails to discover an existing cluster, it forms a new cluster based on a stored cluster configuration information, in step 506. In this case, the initializing WBS 104 may attempt to assume the role of master WBS 104. If another WBS 104 competes to become the master WBS 104, the one with the numerically lowest Ethernet MAC address assumes the role, in one embodiment.

In step 508, initial WBS configuration is performed. Upon joining the cluster, the initializing WBS 104 may send its RF environment information to the master WBS 104. The master WBS 104, using RF information gathered from all cluster members, may determine an RF configuration for the network. The master may disburse RF configuration information to the initializing WBS 104. The initializing WBS 104 adopts the master dictated RF channel, TX power setting and other RF and network parameters on each of its WIFs, in an embodiment. Whether the master distributes RF parameters may depend on the type of group. For example, the master of a fast roaming group selects and disburses RF parameters to the WBS 104 in the fast roaming group, in an embodiment. However, for other types of groups, a WBS 104 selects its own RF parameters, in an embodiment.

In order to maintain each WBS 104, the master WBS 104 distributes configuration and operational parameters throughout the cluster from time to time as needed to adopt changes mandated by the domain administrator or by changing operational conditions, in an embodiment. Thus, in step 510, the configuration/operational parameters are updated as needed. As examples, but not limited hereto, the following can be updated.

Service group parameters

Security information

Base station configuration

Software revision information

Software update information

RF operational parameters

Rogue detection parameters (authorized WBS, desired response when rogue detected, etc.).

### BLANKET ROAMING

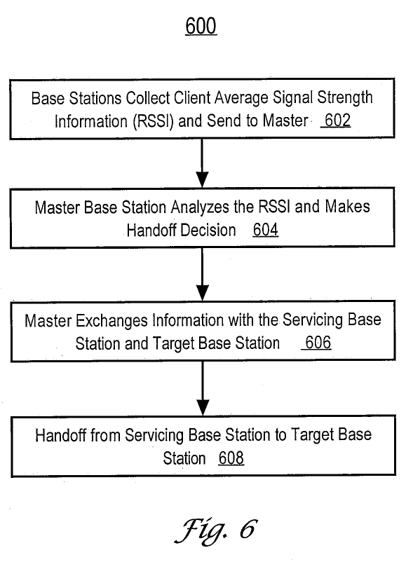

FIG. 6 is a flowchart illustrating a process 600 of roaming, in accordance with an embodiment of the present invention. In step 602, the WBSs 104 in a cluster exchange client RF information with the master WBS 104 to facilitate handoff decisions. For example, the client RF information may include the average strength of signal (RSSI) from the client 106. To identify the client 106, the WBS 104 may send the client's 106 MAC address, although the client 106 could be identified in another way. All the WBS 104 that are able to hear a client 106 communicate the client's 106 information to the master WBS 104, in an embodiment.

In step 604, the master WBS 104 makes handoff decisions based, at least on the RSSI. In one embodiment, the master WBS 104 compares the RSSI information for each client 106 and makes handoff decisions based on RSSI and trend data. In one embodiment, handoff decisions are also based on other factors such as the client 106 load on one or more WBS 104.

When the master WBS 104 decides that a client 106 should be handed off from the WBS 104 that is currently servicing the client 106 to a target WBS 104, the master WBS 104 exchanges certain information with the servicing WBS 104 and target WBS 104 to cause the handoff. For example, upon deciding to cause a handoff, the master WBS 104 requests the client's 106 security information from the servicing WBS 104. Further, the master WBS 104 may send the client's 106 association context (including cryptographic information) to target WBS 104. The master WBS 104 may send a handoff notification to the servicing WBS 104 and to the target WBS 104. The servicing WBS 104 concludes service to the client 106 by deleting its association context for that client 106, in an embodiment. The target WBS 104 commences servicing the client 106 upon receipt of the handoff notification, in an embodiment.

Note that it is the WBSs 104 that collaborate to control the handoff and that the client 106 need not even be aware that a handoff has occurred. In one embodiment, the WBS 104 are made to appear substantially identical to the client 106 such that any logic that resides on the client 106 that might attempt to initiate a handoff is defeated. The WBS 104 are made to appear substantially identical based on how beacons and probe requests are implemented, in an embodiment. For example, the beacons that are sent out by each WBS 104 in a roaming group are substantially the same. As an example, the beacons could be beacon frames in compliance with an IEEE 802.11 protocol; however, the beacons are not limited to an IEEE 802.11 protocol. Furthermore, if the client 106 sends a probe to a WBS 104 to request information about the network, the WBSs 104 respond to the probe in a way that makes each WBS 104 appear to be the same WBS 104. Due to the way beacons and probes are implemented, the client 106 does not know that there are actually multiple WBS 104 and does not attempt to initiate a handoff.

### LOAD BALANCING

The WBS 104 in a cluster collaborate to perform load balancing, in an embodiment. For example, each WBS 104 in a cluster is configured for a maximum load, which could be measured by:

Maximum number of concurrent connections given specific characteristics, such as maximum latency, maximum jitter, delay, etc.

Maxim throughput measured in megabits per second.

However, the maximum load can be measured in another manner. Furthermore, the maximum load can be specified for specific classes of traffic. Requests to connect to a WBS 104 that exceed the maximum load are rejected, in an embodiment. To increase overall system utilization, a handoff mechanism may be employed to allow clients 106 that satisfy specific operational minimums for signal quality to be handed off to participating WBS 104.

The mechanism to shift the load from one WBS 104 to another can be achieved in a similar manner to the way a handoff is performed. However, rather than the master WBS 104 making the handoff decision based on RSSI, the master WBS 104 makes the handoff decision based on load, in an embodiment. Thus, the triggering event for a handoff may be the need for additional capacity on a given WBS 104, resulting in offloading of existing clients 106.

### ROGUE DEVICE DETECTION AND MITIGATION

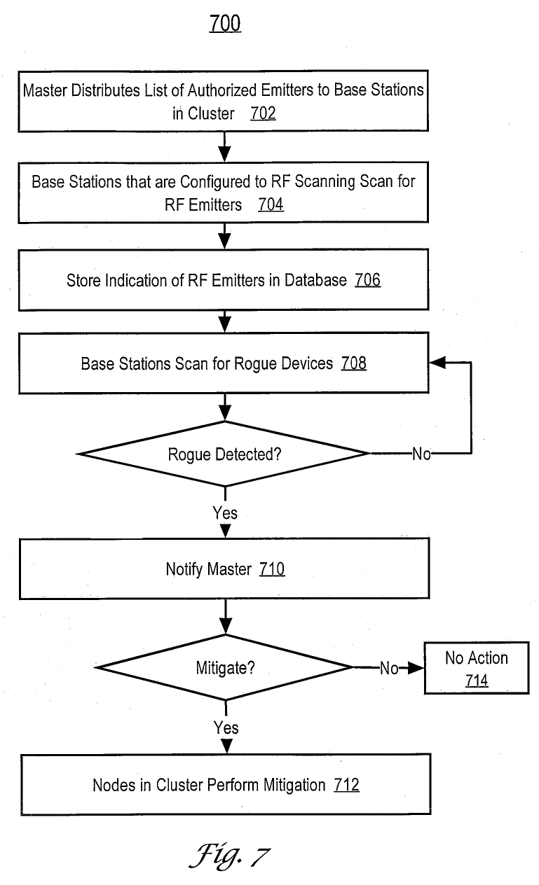

FIG. 7 shows a flowchart illustrating a process 700 of rogue device detection and mitigation, in accordance with an embodiment of the present invention. In step 702, the master WBS 104 distributes, to WBS 104 in the cluster, an authorized emitter database, which contains a list of devices that are authorized to participate in the network. For example, the list could include WBSs 104 that are authorized to be APs to a particular network. At least one of the WBS 104 in the cluster is configured to perform RF monitoring, and can thus use this information when monitoring. WBSs that are not configured for RF monitoring do not take an active part in detecting rogue devices, but might display the list of authorized devices.

In step 704, the WBSs 104 that are configured for RF monitoring scan each channel within the configured bands for RF emitters. In step 706, when an RF emitter is detected, the RF emitter is recorded in a database along with any identifying characteristics such as unique station identifier (MAC address), IP address, etc.

In step 708, the WBS 104 that are configured for RF monitoring scan the configured RF bands and apply a rogue detection test to determine if observed RF emitters are rogue devices. As an example, if a device is advertising itself as an AP to the network and is connected to the network, then it is a “connected AP”, in an embodiment. A device that is a connected AP but not so authorized is considered a rogue, in an embodiment. Another rogue detection test might be performed instead.

If a WBS 104 detects a rogue device, the WBS 104 sends a notification to the master WBS, in step 710. The master WBS 104 makes a determination as to whether mitigation should be performed and instructs the WBSs 104 in the cluster to perform mitigation, in step 712. Otherwise, the master WBS 104 informs the WBSs 104 that no action is to be taken, in step 714. For example, the master WBS 104 sends a configured response, such as “mitigation” or “no action” to each WBS 104 in the cluster.

Rogue mitigation of step 712 proceeds as follows, in one embodiment. All of the WBS 104 in the cluster can participate in rogue mitigation, although it is not required that every WBS 104 participate. The participating WBSs 104 perform a concurrent mitigation protocol, in this embodiment. Several mechanisms are available to disrupt the normal flow of datagrams between communicating rogues. Examples of such mechanisms include, but are not limited to, induced collision, “disconnect” wireless datagrams, and termination of backhaul services. Termination of backhaul services is achieved by termination of service on an Ethernet port, in one embodiment. Depending on the protocols in use between communicating rogues, each WBS 104 attempts to disrupt the rogue communication by employing one or more of the mechanisms identified above, or other mechanisms not specifically identified.

### HARDWARE OVERVIEW

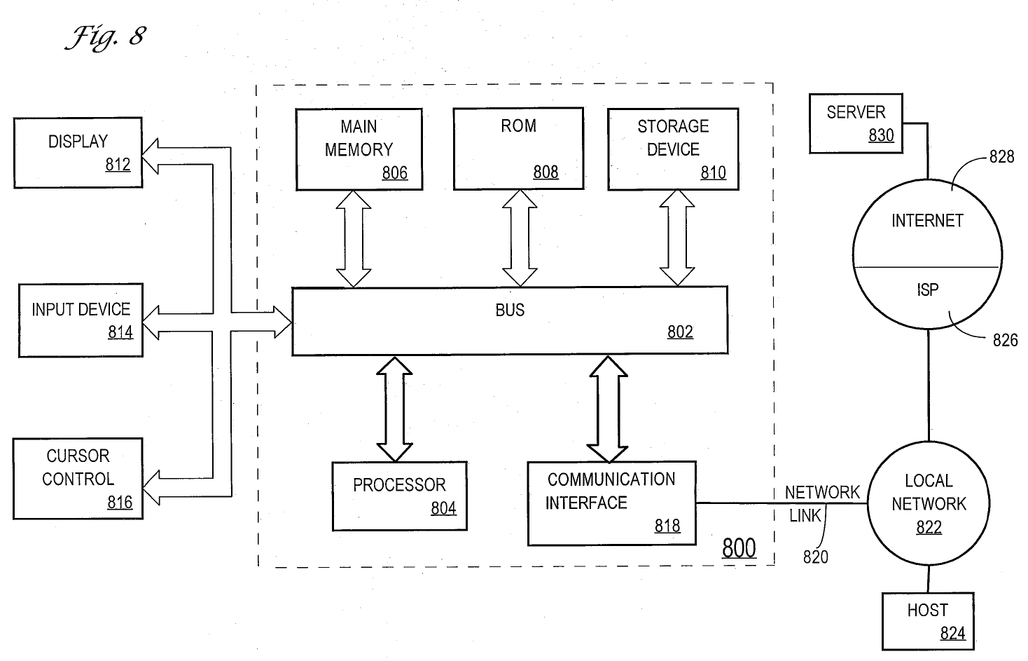

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 800, various machine-readable media are involved, for example, in providing instructions to processor 804 for execution. Such a medium may take many forms, including but not limited to storage media and transmission media. Storage media includes both non-volatile media and volatile media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system comprising:
a plurality of wireless base stations that are communicatively coupled to allow communication between the base stations, wherein each base station comprises:
a wireless network interface to allow client devices to access a network; and
management logic that is operable to:
receive parameters to configure a group of base stations of the plurality of base stations; and
distribute the parameters to the group of base stations in order to configure the group of base stations.

2. The system of claim 1, wherein the management logic is further operable to configure an association between the group of base stations, based on received parameters that define the association.

3. The system of claim 1, wherein the management logic is further operable to:
determine additional parameters to configure the group of base stations; and
distribute the additional parameters to the group of base stations in order to configure the group of base stations.

4. The system of claim 1, wherein the management logic is further operable to:
receive a selection of resources in the group of base stations and a service for the group of base stations to implement by using the selected resources; and
distribute parameters to the group of base stations to cause the group of base stations to implement the service.

5. The system of claim 1, wherein each base station is operable to function as a master in which it receives and distributes the parameters, and wherein if a device acting as the master fails, the remaining devices in the group of base stations are operable to execute a failover mechanism to select a new master.

6. The system of claim 1, wherein each base station further comprises logic that is operable to discover other base stations and to form a cluster of two or more of the base stations.

7. The system of claim 1, wherein each base station further comprises logic that is operable to allow base stations that are in a cluster to collaborate together to provide a service defined for the cluster.

8. The system of claim 1, wherein each base station further comprises storage for storing the parameters, wherein the system comprises a distributed database to configure and maintain the group of base stations.

9. A system comprising:
a plurality of wireless base stations that are communicatively coupled to allow communication between the base stations, wherein each of the base stations comprises:
a wireless network interface to allow client devices to access a network;
logic that is operable to discover other base stations and to form a cluster of two or more of the base stations; and
logic that is operable to allow base stations that are in a cluster to collaborate together to provide a service defined for the cluster.

10. The system of claim 9, wherein the logic that is operable to allow base stations that are in a cluster to collaborate together is operable to collaborate with other base stations in the cluster to hand-off a first client device from one of the base stations to another base station.

11. The system of claim 10, wherein a base station that serves as a master of the cluster makes a hand-off determination based on information provided by at least two of the base stations in the cluster.

12. The system of claim 11, wherein the information includes strength of a signal from the first client device.

13. The system of claim 12, wherein the information further includes load of the client devices on one or more of the base stations.

14. The system of claim 9, wherein the logic that is operable to allow base stations that are in a cluster to collaborate together is operable to collaborate with other base stations in the cluster to detect a rogue device that is attempting to allow access to the network but is not authorized to allow access to the network.

15. The system of claim 9, wherein the logic that is operable to allow base stations that are in a cluster to collaborate together is operable to collaborate with other base stations in the cluster to prevent a rogue device that is attempting to allow access to the network from allowing access to the network.

16. The system of claim 9, wherein the logic that is operable to allow base stations that are in a cluster to collaborate together is operable to collaborate with other base stations in the cluster to load balance client devices that are accessing the network via the base stations in a cluster.

17. The system of claim 9, wherein each of the base stations further comprises storage that stores parameters to implement a service for the cluster.

18. The system of claim 17, wherein each of the base stations further comprises logic, which when acting as a master device in the cluster, executes a protocol to distribute the database parameters.

19. The system of claim 9, wherein each of the base stations further comprises management logic that, when acting as a master, is operable to configure base stations in the cluster.

20. A wireless communications device comprising:
a wireless network interface to allow client devices to access a network;
an interface to allow communication with other wireless communications devices; and
management logic that is operable to:
receive parameters to configure a group of wireless communications devices from the other wireless communications devices; and
distribute the parameters to the group of wireless communications devices in order to configure the group of wireless communications devices.

21. The wireless communications device of claim 20, wherein the management logic is further operable to configure an association between the group of wireless communications devices, based on received parameters that define the association.

22. The wireless communications device of claim 20, wherein the management logic is further operable to:
determine additional parameters to configure the group of wireless communications devices; and
distribute the additional parameters to the group of wireless communications devices in order to configure the group of wireless communications devices.

23. The wireless communications device of claim 20, wherein management logic that is further operable to:
receive a selection of resources in the group of wireless communications devices and a service for the group of wireless communications devices to implement by using the selected resources; and
distribute parameters to cause the group of wireless communications devices to implement the service.

24. The wireless communications device of claim 20, further comprising logic that is operable to execute a failover mechanism to collaborate with other wireless communications devices to select a new master if a wireless communications device acting as a master fails.

25. The wireless communications device of claim 20, further comprising logic that is operable to discover other wireless communications devices and to form a cluster of two or more of the wireless communications devices.

26. The wireless communications device of claim 20, further comprising logic that is operable to collaborate with other wireless communications devices in a cluster to provide a service defined for the cluster.

27. A wireless communications device comprising:
a wireless network interface to allow client devices to access a network;
an interface to allow communication with other wireless communications devices;
logic that is operable to discover other wireless communications devices and to form a cluster of two or more wireless communications devices; and
logic that is operable to collaborate with other wireless communications devices in a cluster to provide a service defined for the cluster.

28. The wireless communications device of claim 27, wherein the logic that is operable to collaborate with other wireless communications devices is operable to collaborate with other devices in the cluster to hand-off a first client device from one of the wireless communications devices to another wireless communications device.

29. The wireless communications device of claim 28, wherein a wireless communications device that serves as a master of the cluster makes a hand-off determination based on information provided by at least one other wireless communications devices in the cluster.

30. The wireless communications device of claim 29, wherein the information includes strength of a signal from the first client device.

31. The wireless communications device of claim 30, wherein the information further includes client load information.

32. The wireless communications device of claim 27, wherein the logic that is operable to collaborate with other wireless communications devices is operable to collaborate with other wireless communications devices in the cluster to detect a rogue device that is attempting to allow access to the network without being authorized to allow network access.

33. The wireless communications device of claim 27, wherein the logic that is operable to collaborate with other wireless communications devices is operable to collaborate with other wireless communications devices in the cluster to prevent a rogue device that is that is attempting to allow access to the network from allowing access to the network.

34. The wireless communications device of claim 27, wherein the logic that is operable to collaborate with other wireless communications devices is operable to collaborate with other wireless communications devices in the cluster to load balance client devices that are accessing the network via the wireless access point devices in a cluster.

35. The wireless communications device of claim 27, further comprising storage that stores parameters to implement a service for the cluster.

36. The wireless communications device of claim 27, further comprising management logic that, when acting as a master, is operable to configure wireless communications device in a cluster.

37. A method of configuring a plurality of wireless base stations, wherein each access point device comprises a wireless network interface to allow client devices to access a network, said method comprising:
receiving, at a first of the base stations, parameters to configure a group of base stations of the plurality of base stations; and
distributing the parameters to the group of base stations in order to configure the group of base stations.

38. The method of claim 37, further comprising configuring an association between the group of base stations, based on received parameters that define the association.

39. The method of claim 37, further comprising:
determining additional parameters to configure the group of base stations; and
distributing the additional parameters to the group of base stations in order to configure the group of base stations.

40. The method of claim 37, further comprising:
receiving a selection of resources in the group of base stations and a service for the selected resources to implement; and
distributing parameters to the group of base stations to cause the group of base stations to implement the service by using the selected resources.

41. The method of claim 37, in response to failure of a base stations acting as a master device that receives and distributes the parameters, executing a failover mechanism to select a new master device.

42. The method of claim 37, further comprising:
discovering other base stations; and
forming a cluster of two or more of the base stations.

43. The method of claim 37, further comprising the group of base stations collaborating together to provide a service defined for the cluster.

44. A method of a plurality of wireless base stations providing a service, wherein each access point device comprises a wireless network interface to allow client devices to access a network, said method comprising:
the plurality of base stations discovering other ones of the base stations;
based on the discovering, two or more of the base stations forming a cluster; and
the base stations that are in a cluster collaborating together to provide a service defined for the cluster.

45. The method of claim 44, further comprising the base stations that are in a cluster collaborating with other base stations in the cluster to hand-off a first client device from a first of the base stations to a second of the base stations.

46. The method of claim 45, further comprising an access point device that serves as a master of the cluster making a hand-off determination based on information provided by at least two of the base stations in the cluster.

47. The method of claim 46, further comprising the at least two of the base stations providing the information to the master.

48. The method of claim 47, wherein the information includes strength of a signal of the first client device.

49. The method of claim 48, wherein the information further includes client load information.

50. The method of claim 44, further comprising the base stations that are in a cluster collaborating with other base stations in the cluster to detect a rogue device that is attempting to allow access to the network without having authorization to allow access to the network.

51. The method of claim 44, further comprising the base stations that are in a cluster collaborating with other base stations in the cluster to prevent a rogue device that is attempting to allow access to the network from allowing access to the network.

52. The method of claim 44, further comprising the base stations that are in a cluster collaborating with other base stations in the cluster to load balance client devices that are accessing the network via the wireless base stations in a cluster.

53. The method of claim 44, further comprising, an access point device, which when acting as a master device in the cluster, executing a protocol to distribute parameters to configure the remaining base stations in the cluster.
